(19) United States
(12) Patent Application Publication
(10) Pub. No.: US 2012/0117045 A1
(43) Pub. Date: May 10, 2012

(54) ENHANCING AN INQUIRY FOR A SEARCH OF A DATABASE

(75) Inventor: Thomas V. Carlock, Montvale, NJ (US)

(73) Assignee: The Dun & Bradstreet Corporation, Short Hills, NJ (US)

(21) Appl. No.: 13/102,199

(22) Filed: May 6, 2011

Related U.S. Application Data
(60) Provisional application No. 61/332,584, filed on May 7, 2010.

(51) Int. Cl. G06F 17/30

(52) U.S. Cl. 707/706; 707/E17.108

(57) ABSTRACT

A database searching, and more particularly, to a technique that utilizes a result from matching an inquiry to data in a first database, and based thereon, prepares an inquiry for a search of a second database. In this regard there is provided a method that includes (a) receiving a first inquiry, (b) matching the first inquiry to first data in a first database, (c) preparing a second inquiry based on the first data, (d) transmitting the second inquiry to a search engine that searches a second database and returns second data, and (e) returning the second data in a response to the first inquiry.

### RELATED APPLICATIONS

This application claim priority to U.S. Provisional Application No. 61/332,584, filed on May 7, 2010, which is incorporated herein in its entirety.

### BACKGROUND

1. Field of the Disclosure

The present disclosure relates to database searching, and more particularly, to a technique that utilizes a result from matching an inquiry to data in a first database, and based thereon, prepares an inquiry for a search of a second database.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

When searching for information in a database, a query that more accurately defines the information of interest will most likely yield a more accurate result. This is particularly the case when searching a large database or searching for data in a plurality of databases such as in the Internet. Accordingly, there is a need for a technique that provides a query that accurately defines the information of interest.

Additionally, when data from a search result is to be utilized by an application, if handling of the data involves manipulation by a human user, the user must spend time to either load the result or insert the result into an appropriate field of the application, e.g., by way of a copy and paste. Such manipulation by the user is prone to human error, and is limited by a rate at which the user works. Accordingly, there is a need for a technique that automatically populates fields of an application with a result of a search.

### SUMMARY

There is provided a method that includes (a) receiving a first inquiry, (b) matching the first inquiry to first data in a first database, (c) preparing a second inquiry based on the first data, (d) transmitting the second inquiry to a search engine that searches a second database and returns second data, and (e) returning the second data in a response to the first inquiry.

There is also provided a system that performs the method, and a storage device that contains instructions for controlling a processor to perform the method.

### BRIEF DESCRIPTION OF THE DRAWINGS

FIG. 1 is a block diagram of a system that includes components that cooperate with one another to embed data from various sources into an application.

FIG. 2 is a signal flow diagram showing an employment of the system of FIG. 1.

FIG. 3 is a signal flow diagram showing an employment of the system of FIG. 1.

FIG. 4 illustrates an embedding of data inside an application, keeping it cleansed and in synch with structured data in a database, and connecting to unstructured data, all through a single platform.

FIG. 5 illustrates data partner participating in a data cloud through a single platform, and delivering data to multiple partners using a DUNS number as a key to obtaining consistent data across organizations.

FIG. 6 illustrates synching structured data in a database, with unstructured data all through a single platform, in applications.

FIG. 7 illustrates an embedding of data inside an application, keeping it cleansed and in synch with structured data from a database, and connecting to unstructured data all through a single platform.

A component or a feature that is common to more than one drawing is indicated with the same reference number in each of the drawings.

### DESCRIPTION OF THE PREFERRED EMBODIMENT

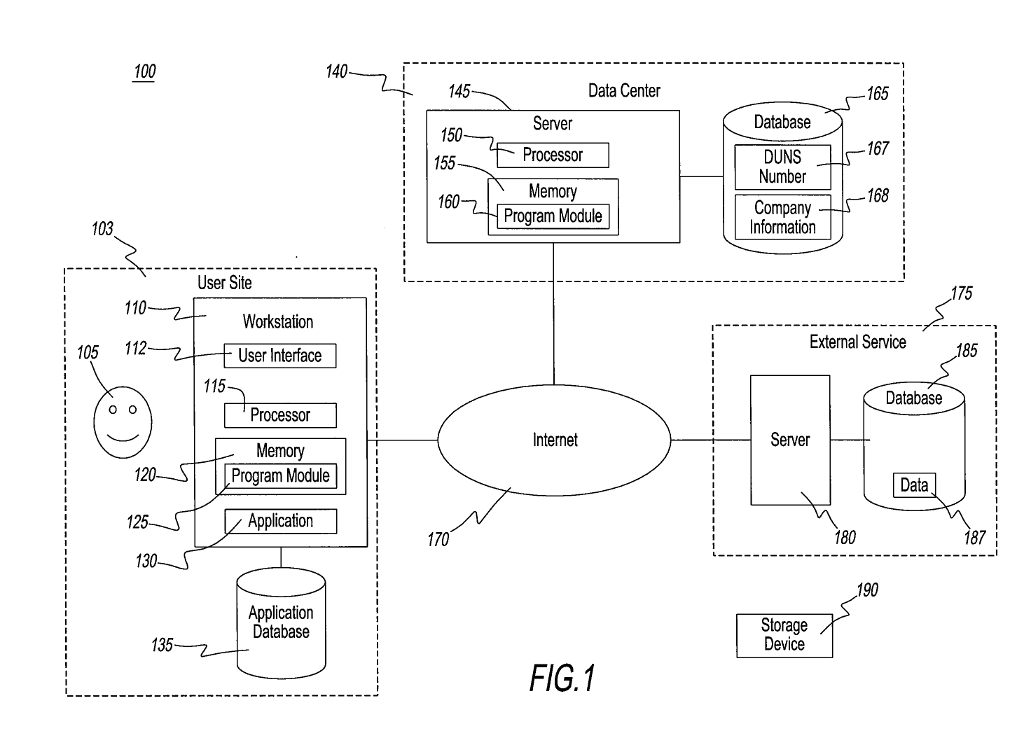

FIG. 1 is a block diagram of a system, i.e., system 100, that includes a user site 103, a data center 140 and an external service 175 communicatively coupled to a data communication network, e.g., the Internet 170.

User site 103 includes a workstation 110 coupled to an application database 135. Workstation 110 includes a user interface 112, a processor 115 and a memory 120. Processor 115 is configured of logic circuitry that responds to and executes instructions, and performs operations on behalf of workstation 110. Memory 120 is a non-transitory computer-readable device that contains instructions that are readable by processor 115, and that, when read by processor 115, control operations performed by processor 115. In this regard, memory 120 contains a program module 125 and an application 130. Memory 120 may be implemented in a random access memory (RAM), a hard drive, a read only memory (ROM), or a combination thereof.

A user 105 interacts with workstation 110 via user interface 112. User interface 112 includes an input device (not shown), such as a keyboard or speech recognition subsystem, for enabling user 105 to communicate information and command selections to processor 115. User interface 112 also includes an output device (not shown) such as a display or a printer. A cursor control such as a mouse, track-ball, or joy stick, allows user 105 to manipulate a cursor on the display for communicating additional information and command selections to processor 115.

Application 130, as will be explained further below, communicates with and receives data from data center 140. In this regard, application 130 can be any application that can utilize such data. Application 130 stores data in application database 135.

Program module 125 facilitates communication between application 130 and data center 140. Program module 125 can be a component of application 130, or a plug-in module that is installed into memory 120 separately from application 130.

As mentioned above, processor 115 performs operations on behalf of workstation 110. More specifically, processor 115 performs operations in accordance with instructions in memory 120, and even more specifically in accordance with instructions in program module 125 and application 130. In the present document, when we describe operations being performed by workstation 110, program module 125 or application 130, the operations are actually being performed by processor 115.

Data center 140 includes a server 145 coupled to a database 165. Server 145 includes a processor 150 and a memory 155. Processor 150 is configured of logic circuitry that responds to and executes instructions, and performs operations on behalf of server 145. Memory 155 is a non-transitory computer-readable device that contains instructions that are readable by processor 150, and that, when read by processor 150, control operations performed by processor 150. In this regard, memory 155 contains a program module 160. Memory 155 may be implemented in a random access memory (RAM), a hard drive, a read only memory (ROM), or a combination thereof.

Database 165 contains information about business entities. For example, for a given business entity, e.g., XYZ Corp., database 165 include a data universal numbering system (DUNS) number 167 and company information 168. Company information 168 includes information about XYZ Corp., for example, sales volume, accounts receivable, accounts payable, lines of credit, and legal proceedings. DUNS is a system developed and regulated by Dun & Bradstreet Corp. that assigns a unique numeric identifier, referred to as a DUNS number, to a single business entity. It is a common standard worldwide. DUNS users include the European Commission, the United Nations and the United States government.

As mentioned above, processor 150 performs operations on behalf of server 145. More specifically, processor 150 performs operations in accordance with instructions in memory 155, and even more specifically in accordance with instructions in program module 160. In the present document, when we describe operations being performed by server 145 or program module 160, the operations are actually being performed by processor 150.

External service 175 includes a server 180 coupled to a database 185.

Each of program module 125 and program module 160 may be implemented as a single module or as a plurality of modules that operate in cooperation with one another. The term “module” is used herein to denote a functional operation that may be embodied either as a stand-alone component or as an integrated configuration of a plurality of sub-ordinate components. Moreover, although program module 125 is described herein as being installed in memory 120 and therefore being implemented in software, and although program module 160 is described herein as being installed in memory 155 and therefore being implemented in software, each of program module 125 and program module 160 can be implemented in any of hardware, e.g., electronic circuitry, firmware, software, or a combination thereof.

Additionally, each of program module 125 and program module 160 can be tangibly embodied on a storage device 190 for subsequent loading into memory 120 or memory 155. Storage device 190 is a computer-readable device and can be any conventional non-transitory storage device, including, but not limited to, a floppy disk, a compact disk, a magnetic tape, a read only memory, an optical storage media, universal serial bus (USB) flash drive, a digital versatile disc, or a zip drive. Storage device 190 could also be a random access memory, or other type of non-transitory electronic storage, located on a remote storage system and coupled to memory 120 or memory 155.

Assume that application 130 is a financial application. Assume further that user 105 is interacting with application 130, and is interested in obtaining information about XYZ Corp., which is a manufacturer of women's apparel. User 105 expresses this interest by way of an appropriate input to application 130, for example, by entering the character string “XYZ Corp.” into a particular field being displayed on user interface 112. User 105 may also provide other information about XYZ Corp., e.g., an address for XYZ Corp. For a case where user 105 does not know the name of the entity, e.g., XYZ Corp., user 105 can provide key words such as “manufacturer” and “women's apparel.” More generally, user 105 can provide any suitable information that can be employed in a search of a database. In any case, for the present example, application 130, notifies program module 125, which, in turn, prepares an inquiry for information about XYZ Corp., and sends the inquiry to program module 160.

Program module 160 receives the inquiry, and based on the inquiry, searches database 165 and matches the inquiry to data in database 165, thus yielding a match result. Matching means searching a database for a record that best matches a given inquiry. Initially, the match result may identify one match, or possibly a plurality of matches. Ordinarily, the more focused the information in the inquiry, the more focused will be the match result. For example, if the inquiry includes both of the name “XYZ Corp.” and the address of XYZ Corp., the match results will be more focused, and therefore fewer in number, than if the inquiry was “manufacturer” and “women's apparel.” For the present example, assume that the match result lists three potential matches, namely (1) XYZ Corp.—corporate headquarters, (2) XYZ Corp.—leather goods, and (3) XYZ Corp.—undergarments. Program module 160 sends the match result to program module 125.

Program module 125 receives the match result and presents it, via application 130 and user interface 112, to user 105. User 105 selects one or more of the match results, thus yielding a selected result. For the present example, assume that user 105 selects “XYZ Corp.—corporate headquarters.” Accordingly, program module 125 notifies program module 160 of the selected result.

Program module 160, upon notification of the selected result, sends data, e.g., company information 168 or a portion thereof, concerning the selected result to program module 125. For convenience, we refer to the data concerning the selected result as “entity data.” The nature of the entity data may depend, in part, on some aspect of application 130. This aspect would be identified by user 105, or automatically recognized by program module 125, when program module 125 is configured for use with application 130. In our present example, application 130 is a financial application. As such, program module 125 would be configured to request financial information from program module 160, and so, accordingly, in the present example, the entity data is financial data. In any case, program module 160 sends the entity data to program module 125. With the entity data, program module 160 also sends the DUNS number for XYZ Corp.—corporate headquarters, e.g., DUNS number 167.

Program module 125 receives the entity data, and forwards it to application 130, and application 130 processes the entity data. For example, if application 130 is preparing a credit report about XYZ Corp., program module 125 automatically populates particular fields in the credit report with the entity data. Program module 125 also stores the entity data, via application 130, in application database 135.

In practice, data in database 165 is regularly updated, perhaps many times a day, and maybe even several times a second. Regardless of how often database 165 is updated, suffice to say that after some period of time, the entity data that is sent from program module 160 to program module 125, and stored in application database 135, will become outdated. Thus, system 100 provides for a subsequent updating of the entity data in application database 135. The updating can be initiated by either of (a) program module 125 requesting an update from program module 160, or (b) program module 160 offering updated information to program module 125. The updating can be performed periodically, e.g., on a daily basis, or initiated in response to an occurrence of an event. For example, (a) program module 125 can be configured to request an update when application 130 is opened or started, or (b) program module 160 can be configured to monitor entity data in database 165 for a change, and upon detection of the change, notifies program module 125 of the change.

In any case, the updating is facilitated by employing the DUNS number that was included with the entity data that was previously obtained. That is, program module 125 can request an update based on the DUNS number, or program module 160 can monitor entity data in database 165, based on the DUNS number. The use of the DUNS number allows for more efficient searching and matching of data in database 165, as compared to a situation in which the DUNS number is not available.

System 100 also provides for usage of services other than that of data center 140, and for usage of data from databases other than database 165. That is, services and other databases that are accessible via Internet 170 can be utilized for the benefit of application 130. Data from such other databases can be unstructured, but program module 160 and/or program module 125 will organize the unstructured data so that it can be utilized by application 130 and stored in application database 135. External service 175 is one example of such a service.

Unstructured data refers to information that either does not have a pre-defined data model and/or does not fit well into relational tables. Unstructured data is typically text-heavy but may contain data such as dates, numbers, and facts as well. For example, a database for a social networking service may include personal information in the form of a narrative in text format.

Structured data refers to data that conforms to a data model that documents and organizes the data for communication, and defines how the data is stored and accessed. For example, a database of information about business entities may organize records such that particular information (e.g., DUNS number, revenue, and current stock price) are in particular fields.

Assume that external service 175 is a social networking service with which a plurality of users has registered and provided some personal information. For example, assume that John Doe is the president of XYZ Corp., and that John Doe has registered and provided some personal information to external service 175. The personal information is stored in database 185 as data 187.

Program module 125 is configured to present an icon, via application 130, for external service 175. As described above, user 105 has previously obtained entity information about XYZ Corp., and the entity information includes the DUNS number for XYZ Corp. User 105 selects the icon, and indicates a desire to obtain information about the president of XYZ Corp. Accordingly, program module 125 obtains the DUNS number of XYZ Corp. from application database 135. Depending on configurations of program module 125 and program module 160, program module 125 can either (a) obtain data from external service 175 on its own, or (b) obtain data from external service 175 in cooperation with program module 160.

For the case where program module 125 obtains data from external service 175 on its own, program module 125 includes the DUNS number in an inquiry that it sends to server 180. The inquiry also includes a request for information about the president of XYZ Corp.

For the case where program module 125 obtains data from external service 175 in cooperation with program module 160, program module 125 includes the DUNS number in a first inquiry that it sends to program module 160. The first inquiry also includes a request for information about the president of XYZ Corp., and further indicates that the requested information be obtained from external service 175. Program module 160 receives the first inquiry, and in response, utilizes the DUNS number to match the first inquiry to data in database 165, to identify the president of XYZ Corp. Program module 160 prepares a second inquiry, i.e., an enhanced inquiry, based on the data from database 165. The second inquiry is enhanced in the sense that it may include data from the first inquiry as well as data from database 165, and is therefore more focused than the first inquiry. Thereafter, program module 160 (i) transmits the second inquiry to server 180, which returns the personal information, i.e., data 187, from database 185, and (ii) sends the personal information to program module 125.

Program module 125 thus receives the personal information, from either server 180 or program module 160, and presents it, via application 130 and user interface 112, to user 105.

One of the features of program module 125 is that from the perspective of user 105, it operates within application 130. That is, user 105 is interacting with application 130 in a conventional manner, without having to exit from application 130, and without having to separately invoke program module 125. This minimizes the manipulation of data by user 105, and thus saves time and minimizes the opportunity for errors by user 105.

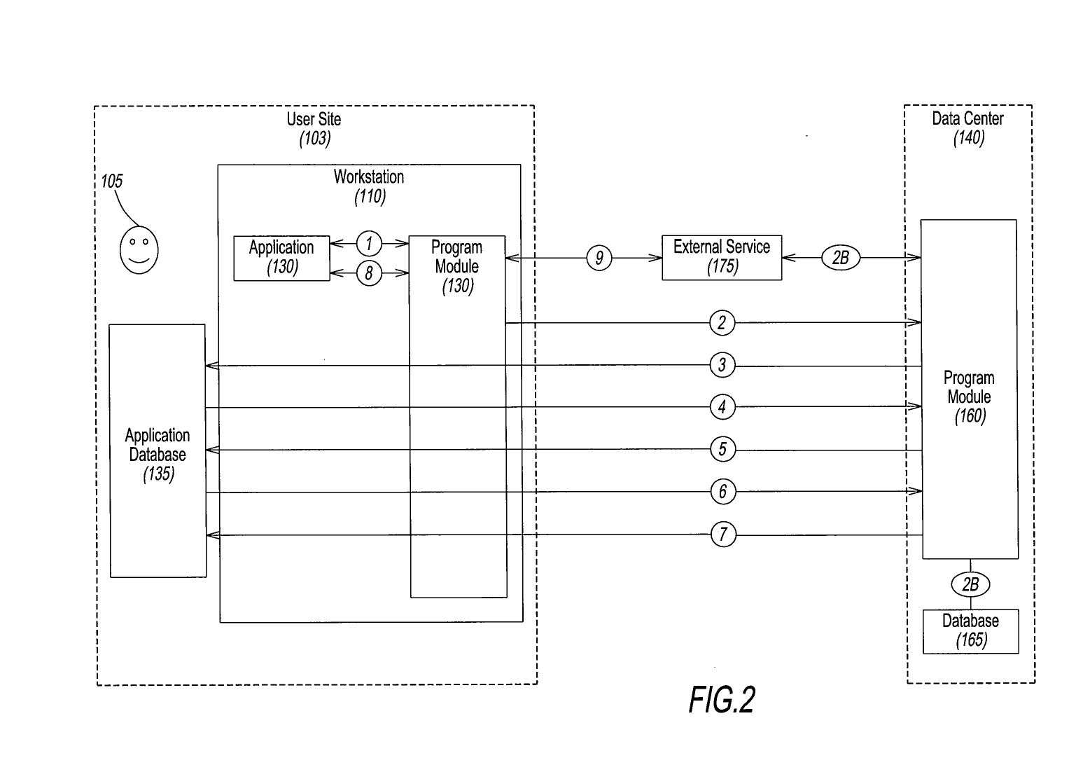

FIG. 2 is a signal flow diagram showing another employment of system 100. Steps are identified by numbers in ovals. The steps are described below.

In step 1, user 105 is interacting with application 130, and requests information about a business entity. For example, assume that user 105 is seeking a stock price for XYZ Corp. Program module 125, through interaction with application 130, prepares a first inquiry. Assume that the first inquiry is, “XYZ Corp. stock price”.

In step 2, program module 125 sends the first inquiry to program module 160.

In step 2A, program module 160 matches the first inquiry to data in database 165, thus yielding a match result.

Assume that the match result is a match to DUNS number 167 and company information 168. In the present example, DUNS number 167 is the DUNS number for XYZ Corp., and company information 168 includes information about XYZ Corp. such as sales volume, accounts receivable, accounts payable, lines of credit, and legal proceedings, but does not include the stock price. Accordingly, program module 160 realizes that it needs to obtain information that is not available in database 165. Assume therefore, for the present example, that database 185, which is accessed via external service 175, contains stock information in a structured data format, and that the stock information for a company of interest can be accessed by specification of the company's DUNS number. Accordingly, program module 160 prepares a second inquiry that includes DUNS number 167. In this case, the second inquiry is enhanced as compared to the first inquiry because the second inquiry includes DUNS number 167, which uniquely identifies XYZ Corp. and therefore provides for a more focused search than would the first inquiry.

In step 2B, program module 160 transmits the second inquiry to external service 175. External service 175 returns the stock price for XYZ Corp.

In step 3, program module 160 sends the match result to program module 125. In the present example, the match result includes the stock price, DUNS number 167, and company information 168. Program module 125 receives the match result, populates fields of application 130 with appropriate data from the match result, and stores the match result in application database 135.

In step 4, program module 125 performs a scheduled process, set by user 105, to automate a sending of bulk data from application database 135 to data center 140, where program module 160 matches the bulk data to data in database 165.

In step 5, program module 160 returns the results of the process in step 4, and in cooperation with program module 125, automates storage of data from database 165 into application database 135. Thus, application database 135 is periodically, automatically updated with data from database 165.

In step 6, program module 125 performs a scheduled process, set by user 105, to automate a sending of bulk data from application database 135 to data center 140 for refreshing data in database 165.

In step 7, program module 160 returns the results of the process in step 6, and in cooperation with program module 125, automates storage of data from database 165 into application database 135. Thus, application database 135 is kept up-to-date with data from database 165.

In step 8, user 105 is interacting with application 130, and requests information from external service 175. Program module 125 can either (a) prepare an inquiry, and send the inquiry to program module 160, as described in steps 1 and 2, or (b) if program module 125 has access to sufficient information, e.g., DUNS number 167 from a prior inquiry, prepare an inquiry and send the inquiry to external service 175. For the present example, assume that program module 125 has access to sufficient information from a prior inquiry.

In step 9, program module 125 passes a duns number as a parameter to external service 175, and more particularly to server 180, which in the present example, returns data from database 185. Thereafter, program module 125 presents a view of the data to user 105 within application 130.

Data from database 185 may be in either a structured format at or an unstructured format. In any case, the data can be stored in application database 135 if user 105 chooses.

In the present example, external service 175 is described as a service for a specific function, i.e., providing stock prices, and to which, in step 2B, program module 160 transmitted an inquiry that included DUNS number 167. However, external service 175 can be a generic search utility, e.g., an Internet search engine, for which program module 160 would prepare an inquiry that could include some or all of company information 168, instead of, or in addition to DUNS number 167.

In summary processor 150, pursuant to instructions in program module 160, performs a method that includes:
(a) receiving a first inquiry from program module 125;
(b) matching the first inquiry to first data in database 165;
(c) preparing a second inquiry based on the first data;
(d) transmitting the second inquiry to a search engine, e.g., server 180, that searches a second database, e.g., database 185, and returns second data; and
(e) returning the second data to program module 125 in a response to the first inquiry.

The first data, from database 165, may include a DUNS number, and accordingly, when preparing the second inquiry, processor 150 includes the DUNS number in the second inquiry. Alternatively, the first inquiry from program module may include the DUNS number, and accordingly, processor 150 matches the DUNS number to the first data in database 165.

The second data, from database 185, may include information in either of a structured format or an unstructured format, e.g., a narrative in text format.

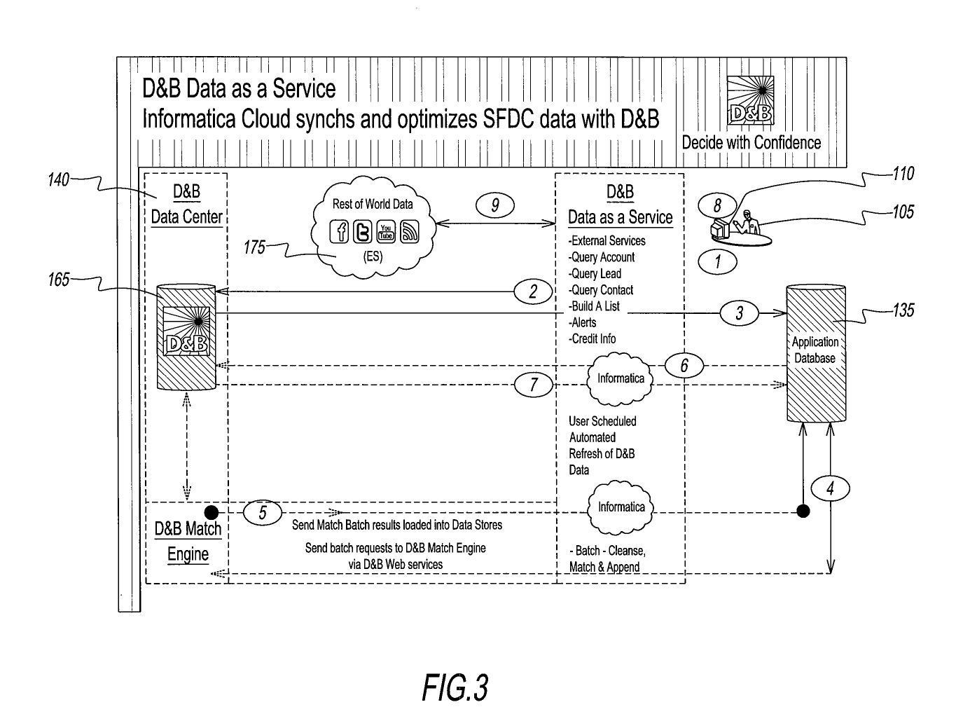

FIG. 3 is a signal flow diagram showing an employment of system 100. In particular, it shows nine steps that are identified by numbers in ovals. The steps are described below.

In step 1, user 105 is interacting with application 130, and requests information about an entity. Program module 125 prepares and inquiry, and sends the inquiry to program module 160.

In step 2, program module 160 receives the inquiry, and matches the inquiry to data in database 165, thus yielding a match result. In computer parlance, this activity may be referred to as a “get” for a single transaction of information. Program module 160 sends the match result to program module 125.

In step 3, program module 125 receives the match result and stores it in application database 135.

In step 4, program module 125 performs a scheduled process, set by user 105, to automate a sending of bulk data to data center 145 for cleansing, matching and appending data in database 165.

In step 5, program module 160 returns the results of the process in step 4, and in cooperation with program module 125, automates a storage of data from database 165 into application database 135.

In step 6, program module 125 performs a scheduled process, set by user 105, to automate a sending of bulk data to data center 145 for refreshing data in database 165.

In step 7, program module 160 returns the results of the process in step 6, and in cooperation with program module 125, automates storage of data from database 165 into application database 135.

In step 8, user 105 is interacting with application 130, and requests information from external service 175. Program module 125 prepares and inquiry, and sends the inquiry to program module 160.

In step 9, program module 125 passes structured data as a parameter to external service 175, and more particularly to server 180, which returns unstructured data from database 185. Thereafter, program module 125 presents a view of the unstructured data to user 105 within application 130. Unstructured data can be stored in application database 135 if user 105 chooses.

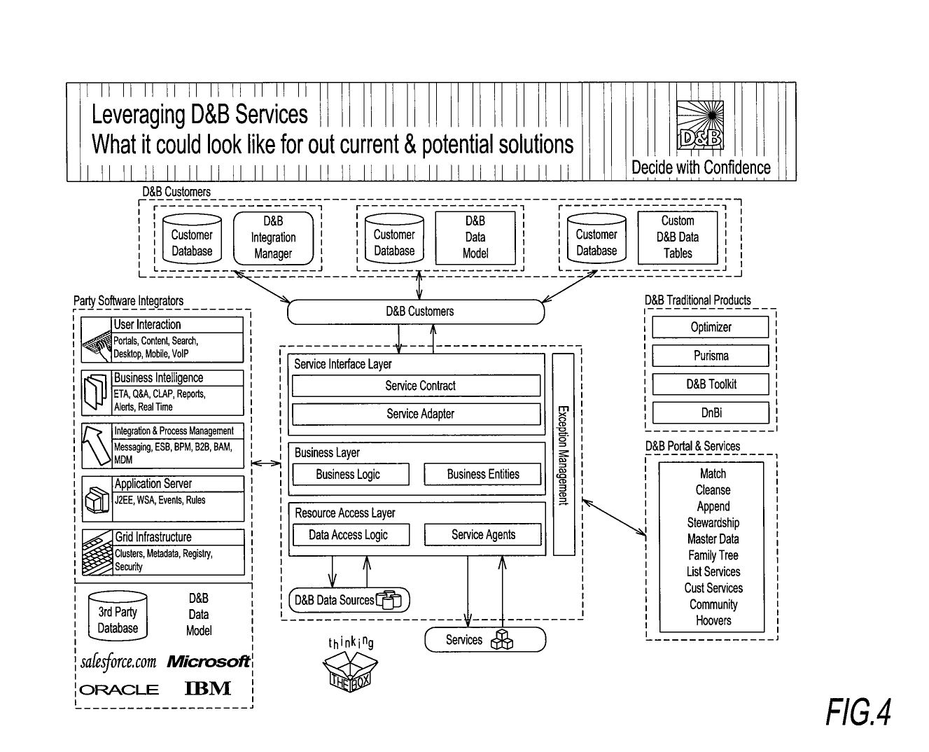

FIG. 4 illustrates an embedding of data inside application 130, keeping it cleansed and in synch with structured data in database 165, and connecting to unstructured data, e.g., data in database 185, all through a single platform.

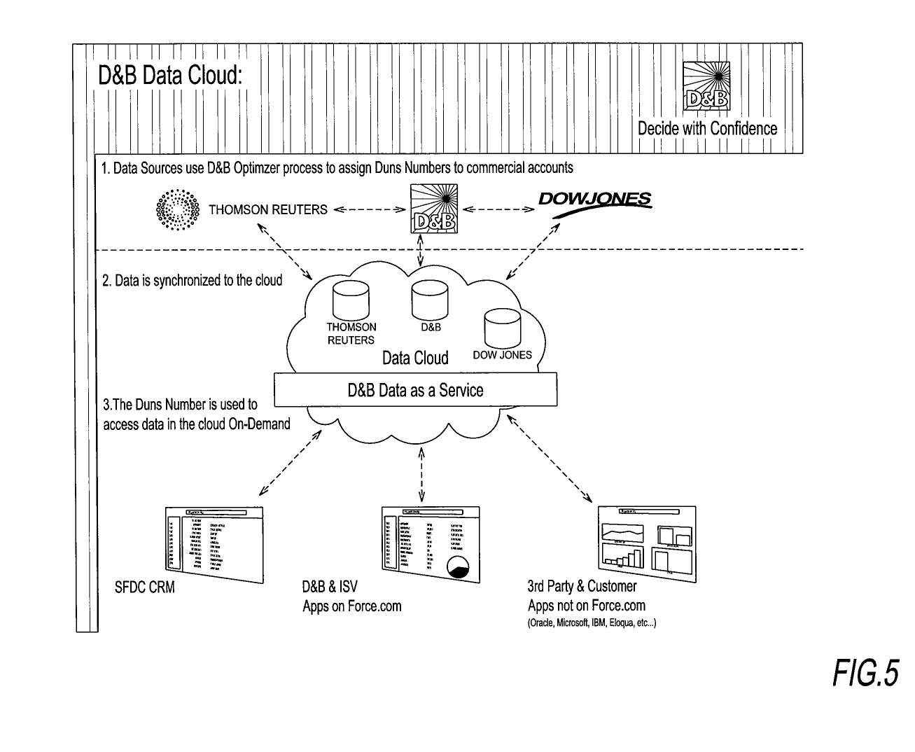

FIG. 5 illustrates data partner participating in a data cloud through a single platform, and delivering data to multiple partners using a DUNS number as a key to obtaining consistent data across organizations.

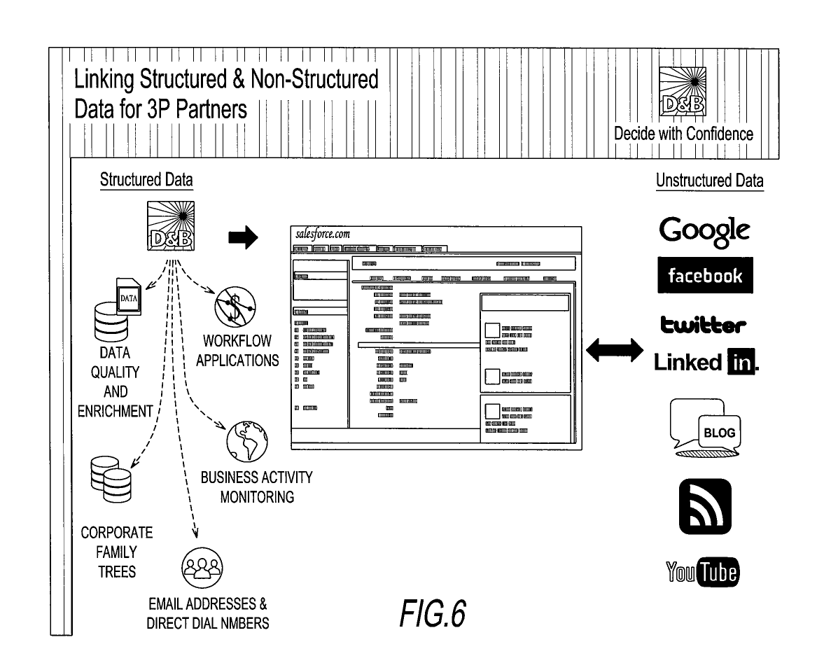

FIG. 6 illustrates synching structured data in database 165, with unstructured data all through a single platform, in applications.

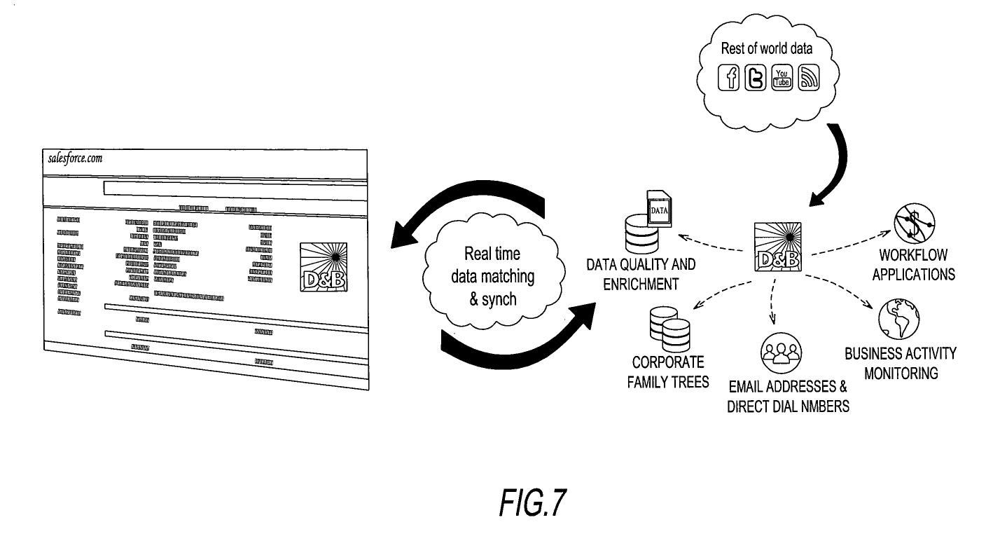

FIG. 7 illustrates an embedding of data inside application 130, keeping it cleansed and in synch with structured data from database 165, and connecting to unstructured data all through a single platform.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. Also, although database 165 is being described herein as containing information about business entities, and application 130 is described as being a financial application, system 100 is not limited to processing business or financial information. Instead, database 165 can contain information about any subject, and application 130 can also concern any subject. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method comprising:
receiving a first inquiry;
matching said first inquiry to first data in a first database;
preparing a second inquiry based on said first data;
transmitting said second inquiry to a search engine that searches a second database and returns second data; and
returning said second data in a response to said first inquiry.

2. The method of claim 1,
wherein said first data includes a data universal numbering system (DUNS) number that identifies a business entity, and
wherein said preparing comprises including said DUNS number in said second inquiry.

3. The method of claim 1,
wherein said first inquiry includes a data universal numbering system (DUNS) number that identifies a business entity, and
wherein said matching matches said DUNS number to said first data.

4. The method of claim 1, wherein said second data includes information in a structured format.

5. The method of claim 1, wherein said second data includes information in an unstructured format.

6. The method of claim 5, wherein said information in said unstructured format is a narrative in text format.

7. A system comprising:
a processor; and
a memory that contains instructions that when read by said processor, cause said processor to:
receive a first inquiry;
match said first inquiry to first data in a first database;
prepare a second inquiry based on said first data;
transmit said second inquiry to a search engine that searches a second database and returns second data; and
returns said first data and said second data in a response to said first inquiry.

8. The system of claim 7,
wherein said first data includes a data universal numbering system (DUNS) number that identifies a business entity, and
wherein said instructions, to cause said processor to prepare said second inquiry, cause said processor to include said DUNS number in said second inquiry.

9. The system of claim 7,
wherein said first inquiry includes a data universal numbering system (DUNS) number that identifies a business entity, and
wherein said instructions, to cause said processor to match said first inquiry, cause said processor to match said DUNS number to said first data.

10. The system of claim 7, wherein said second data includes information in a structured format.

11. The system of claim 7, wherein said second data includes information in an unstructured format.

12. The system of claim 11, wherein said information in said unstructured format is a narrative in text format.

13. A storage device comprising instructions that are readable by a processor, and that when read by said processor cause said processor to:
receive a first inquiry;
match said first inquiry to first data in a first database;
prepare a second inquiry based on said first data;
transmit said second inquiry to a search engine that searches a second database and returns second data; and
returns said first data and said second data in a response to said first inquiry.

14. The storage device of claim 13,
wherein said first data includes a data universal numbering system (DUNS) number that identifies a business entity, and
wherein said instruction, to cause said processor to prepare said second inquiry, cause said processor to include said DUNS number in said second inquiry.

15. The storage device of claim 13,
wherein said first inquiry includes a data universal numbering system (DUNS) number that identifies a business entity, and
wherein said instructions, to cause said processor to match said first inquiry, cause said processor to match said DUNS number to said first data.

16. The storage device of claim 13, wherein said second data includes information in a structured format.

17. The storage device of claim 13, wherein said second data includes information in an unstructured format.

18. The storage device of claim 17, wherein said information in said unstructured format is a narrative in text format.
